(19) United States
(12) Patent Application Publication
(10) Pub. No.: US 2026/0113563 A1
(43) Pub. Date: Apr. 23, 2026

(54) HEADSET

(71) Applicant: Luxshare Precision Industry Company Limited, SHENZHEN (CN)

(72) Inventor: Shu-Min QIU, SHENZHEN (CN)

(73) Assignee: Luxshare Precision Industry Company Limited, SHENZHEN (CN)

(21) Appl. No.: 19/022,486

(22) Filed: Jan. 15, 2025

(30) Foreign Application Priority Data
Oct. 22, 2024 (CN) 202411482069.2

(51) Int. Cl. H04R 1/10

(52) U.S. Cl. CPC H04R 1/105; H04R 1/1033; H04R 1/1066

(57) ABSTRACT

A headset is provided and relates to the technical field of earphones. The headset includes a headband housing and an headset body. The headband housing is provided with an extension opening. The headset further includes a sliding bracket, an adjustment member, and a damping compression assembly. The sliding bracket is disposed in the headband housing and provided with a first through hole. The adjustment member is movably inserted through the first through hole, extends out from the extension opening, and is connected to the headset body. The damping compression assembly is connected to the adjustment member and used for compressing and fixing the adjustment member to the sliding bracket.

### CROSS-REFERENCE TO RELATED APPLICATION

This application claims priority to Chinese patent application No. 202411482069.2 filed with the China National Intellectual Property Administration (CNIPA) on Oct. 22, 2024, the disclosure of which is incorporated herein by reference in its entirety.

### TECHNICAL FIELD

The present disclosure relates to the technical field of earphones and, in particular, to a headset.

### BACKGROUND

A headset refers to a type of earphone worn on a head, mainly constituted by three parts: headset bodies, brackets, and a headband. Headsets do not need to be inserted into ears, so they offer better comfort and are favored by users.

In the related art, to expand the application range of a headset, a headset body is typically limited in a damping manner through a toothed structure. Specifically, the toothed structure is disposed between a bracket and a headband, and the bracket is movable relative to the headband, thereby adjusting the distance between the headset body and the headband to suit users with different head sizes. However, due to the gap between teeth of the toothed structure, the minimum step size of the movement of the headset body is typically the distance between two adjacent teeth, resulting in relatively low adjustment precision of the headset. That is, the bracket cannot be limited to every position. As a result, headset bodies are positioned a little bit high or low and cannot completely cover ears, affecting the wearing comfort and sound quality of the headset.

Therefore, a headset is urgently needed to solve the preceding problems.

### SUMMARY

The present disclosure provides a headset to solve the technical problem that stepless adjustment cannot be implemented in the related art.

The present disclosure adopts the technical solutions below.

A headset includes a headband housing and an headset body, where the headband housing is provided with an extension opening. The headset further includes a sliding bracket, an adjustment member, and a damping compression assembly.

The sliding bracket is disposed in the headband housing and provided with a first through hole.

The adjustment member is movably inserted through the first through hole, extends out from the extension opening, and is connected to the headset body.

The damping compression assembly is connected to the adjustment member and used for compressing and fixing the adjustment member to the sliding bracket.

In some embodiments, the damping compression assembly includes a connecting sleeve, a compression block, and a connector, the connecting sleeve is sleeved on the adjustment member, a feature side surface of the sliding bracket is provided with a guide groove communicating with the first through hole, the compression block is passed through the guide groove and is abutted against the connecting sleeve, the connector connects the compression block to the connecting sleeve, and the compression block is provided with a compression surface abutting against the feature side surface.

In some embodiments, the compression block is provided with a second through hole, the connector is inserted through the second through hole, one end of the connector is connected to the connecting sleeve, and a cap portion is disposed at another end of the connector.

The damping compression assembly further includes an elastic member, the elastic member is sleeved on the connector and disposed between the cap portion and the compression block, and the elastic member always has a movement trend to drive the compression block to compress the adjustment member against the sliding bracket.

In some embodiments, the connecting sleeve is provided with a first threaded hole, the adjustment member is provided with a second threaded hole, and the connector is in threaded connection to the first threaded hole and the second threaded hole to connect the connecting sleeve to the adjustment member.

In some embodiments, one of a hole wall of the first through hole and the outer peripheral wall surface of the connecting sleeve is provided with a first sliding groove, the other one of the hole wall of the first through hole and the outer peripheral wall surface of the connecting sleeve is provided with a sliding block, the extension direction of the first sliding groove is the same as the extension direction of the first through hole, and the sliding block is slidably connected to the first sliding groove along the extension direction of the first sliding groove.

Additionally or alternatively, the sliding bracket is provided with a sliding rail extending along the extension direction of the first through hole, and the compression block is provided with a second sliding groove in a sliding fit with the sliding rail.

In some embodiments, a collar and a first limit structure are disposed at one end of the sliding bracket, a second limit structure is disposed at the other end of the sliding bracket, the collar is connected to the headband housing and located on a side of the first limit structure facing away from the second limit structure, and the adjustment member is inserted through the collar.

The compression block has a first position and a second position, the length of the adjustment member extending out from the extension opening when the compression block is at the first position is greater than the length of the adjustment member extending out from the extension opening when the compression block is at the second position, and the first limit structure is used for contact with the compression block at the first position and the second limit structure is used for contact with the compression block at the second position so that a movement limit of the compression block in the extension direction of the first through hole is limited.

In some embodiments, two headset bodies, two sliding brackets, two adjustment members, and two damping compression assemblies are provided, the two sliding brackets are respectively disposed at two ends of the headband housing, the two adjustment members are correspondingly inserted through first through holes of the two sliding brackets, the two damping compression assemblies are correspondingly connected to the two adjustment members and are used for compressing and fixing each of the adjustment members to a respective one of the sliding brackets, the two headset bodies are correspondingly connected to the two adjustment members correspondingly, the headset further includes a wire, the middle portion of the wire is located in the headband housing, and two ends of the wire are correspondingly passed through the adjustment members correspondingly and are electrically connected to the two headset bodies.

In some embodiments, the headset further includes a support sheet slidably connected to the sliding bracket, and the support sheet, the sliding bracket, and the damping compression assembly are all disposed in the headband housing.

In some embodiments, the headband housing includes an upper housing and a lower housing that are in snap-fit connection to each other, the lower housing is closer to the geometric center of the headset than the upper housing, the lower housing is provided with a mounting slot, the support sheet, the sliding brackets, and the damping compression assembly are all disposed in the mounting slot, the sliding bracket is connected to the lower housing, and the support sheet is disposed on a side of the sliding brackets facing away from the bottom wall of the mounting slot.

In some embodiments, the support sheet and the damping compression assembly are disposed on the same side of the sliding bracket.

### BRIEF DESCRIPTION OF DRAWINGS

To illustrate technical solutions in embodiments of the present disclosure more clearly, the drawings used in the description of the embodiments of the present disclosure are briefly described below. Apparently, the drawings described below illustrate only part of the embodiments of the present disclosure, and those of ordinary skill in the art may obtain other drawings based on the content of the embodiments of the present disclosure and the drawings on the premise that no creative work is done.

FIG. 1 is a structural view of a headset according to an embodiment of the present disclosure;

FIG. 2 is an exploded view of a headset according to an embodiment of the present disclosure;

FIG. 3 is a structural view of part of a headset according to an embodiment of the present disclosure;

FIG. 4 is a structural view of a sliding bracket according to an embodiment of the present disclosure;

FIG. 5 is a structural view showing a damping compression assembly and an adjustment member according to an embodiment of the present disclosure;

FIG. 6 is a structural view of a compression block according to an embodiment of the present disclosure;

FIG. 7 is a top view of a headset according to an embodiment of the present disclosure;

FIG. 8 is a sectional view taken along A-A in FIG. 7 according to the present disclosure;

FIG. 9 is an enlarged view of a part B in FIG. 8 according to the present disclosure; and

FIG. 10 is a schematic view showing a support sheet, a wire, and an adjustment member according to an embodiment of the present disclosure.

### REFERENCE LIST

100 headband housing
101 extension opening
110 upper housing
120 lower housing
121 mounting slot
122 snapping slot
200 sliding bracket
201 feature side surface
210 first through hole
220 guide groove
230 first sliding groove
240 sliding rail
250 second limit structure
260 first limit structure
270 collar
280 support protrusion
290 snap
300 adjustment member
310 second threaded hole
320 small-diameter end
400 damping compression assembly
410 compression surface
420 connecting sleeve
421 first threaded hole
422 sliding block
430 compression block
431 second through hole
432 second sliding groove
440 connector
450 cap portion
460 elastic member
500 wire
510 wavy section
520 arc-shaped section
600 support sheet
610 avoidance slot
620 elongated hole
700 first position
800 second position
900 headset body

### DETAILED DESCRIPTION

To make the solved technical problems, adopted technical solutions, and achieved technical effects of the present disclosure more apparent, the technical solutions of the present disclosure are further described below in conjunction with the drawings and the embodiments. It is to be understood that the embodiments described herein are intended to explain the present disclosure and not to limit the present disclosure. Additionally, it is to be noted that for ease of description, only part, not all, of structures related to the present disclosure are illustrated in the drawings.

It is to be noted that similar reference numerals and letters represent similar items in the drawings. Therefore, once an item is defined in one drawing, the item no longer needs to be defined and interpreted in the subsequent drawings.

In the description of the present disclosure, the terms “joined”, “connected”, and “fixed” are to be understood in a broad sense unless otherwise expressly specified and limited. For example, the term “connected” may refer to “fixedly connected”, “detachably connected”, or “integrated”, may refer to “mechanically connected” or “electrically connected”, may refer to “connected directly” or “connected indirectly through an intermediary”, or may refer to “connected inside two elements” or “an interaction relation between two elements”. For those of ordinary skill in the art, specific meanings of the preceding terms in the present disclosure may be understood based on specific situations.

In the present disclosure, unless otherwise expressly specified and limited, when a first feature is described as “above” or “below” a second feature, the first feature and the second feature may be in direct contact, or the first feature and the second feature may be in contact via another feature between the two features instead of being in direct contact. Moreover, when the first feature is described as being “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature. In the description of the embodiments herein, “multiple” means two or more unless otherwise specified.

In the description of the embodiment of the present disclosure, orientations or position relations indicated by terms such as “upper”, “lower”, and “right” are based on the drawings. These orientations or position relations are intended only to facilitate description and simplify operations and not to indicate or imply that a device or element referred to must have such particular orientations or must be configured or operated in such particular orientations. Thus, these orientations or position relations are not to be construed as limiting the present disclosure. In addition, the terms “first” and “second” are only used for distinguishing between descriptions and have no special meanings.

It is to be noted that when an element is described as being “fixed to” or “disposed on” another element, the element may be directly on the particular element or an intervening element may be on the particular element.

Technical solutions in the present disclosure are further described below in conjunction with the drawings and embodiments.

the embodiment of the present disclosure provides a headset that can implement stepless adjustment and has relatively high adjustment precision, thereby improving wearing comfort and ensuring sound quality.

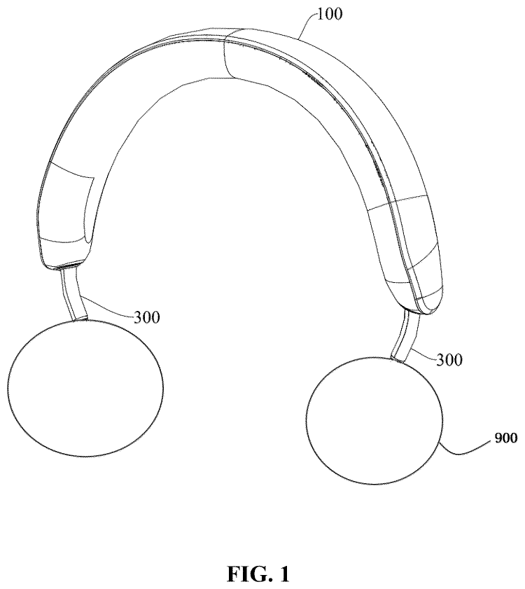

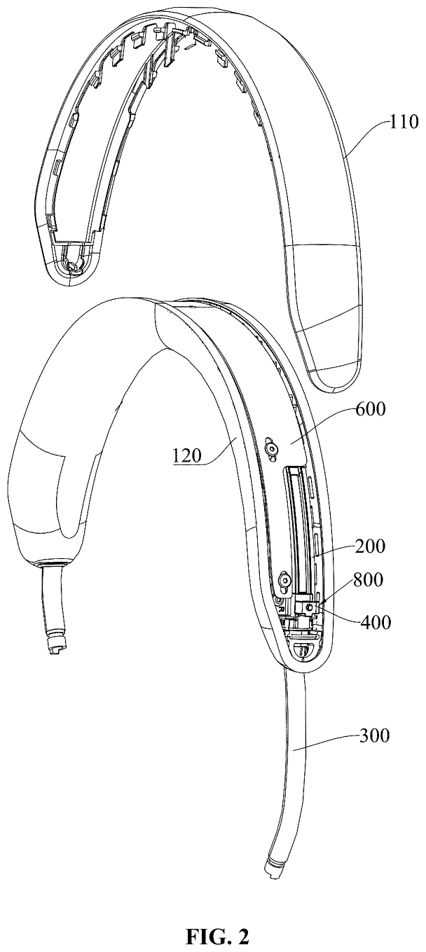

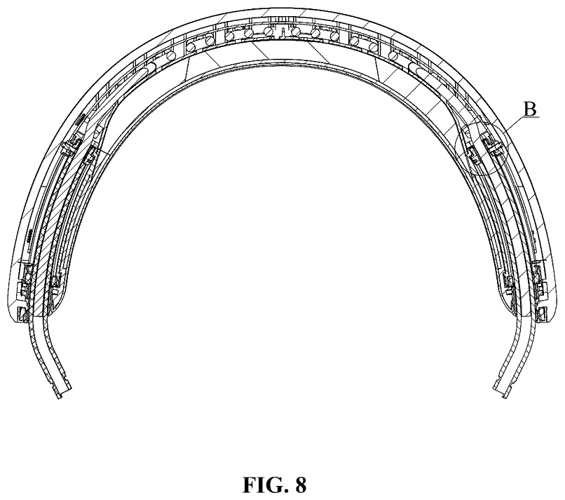

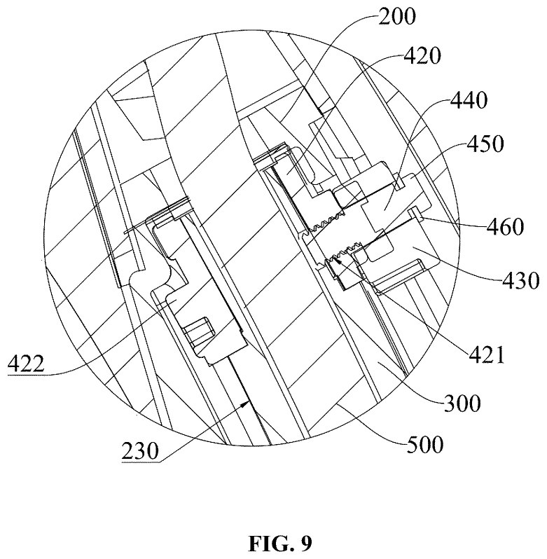

As shown in FIGS. 1 to 10, the headset includes a headband housing 100, headset bodies 900, sliding brackets 200, adjustment members 300, and damping compression assemblies 400. The number of the headset bodies 900 is two. Both of the two headset bodies 900 are able to produce sound and are used for covering a user's ears so that the sound produced by the headset bodies 900 enters the ears. The headband housing 100 is provided with extension openings 101 from which the adjustment members 300 extend out. In an example, the headband housing 100 is in a long strip shape and has the extension openings 101 at its two ends. The adjustment members 300 extend out from the extension openings 101 and are connected to the headset bodies 900. Thus, the moving adjustment members 300 can drive the headset bodies 900 to move, thereby adjusting the positions of the headset bodies 900 relative to the headband housing 100. It is to be noted that the connections between the headset bodies 900 and the adjustment members 300 are fixed connections, rather than electrical connections.

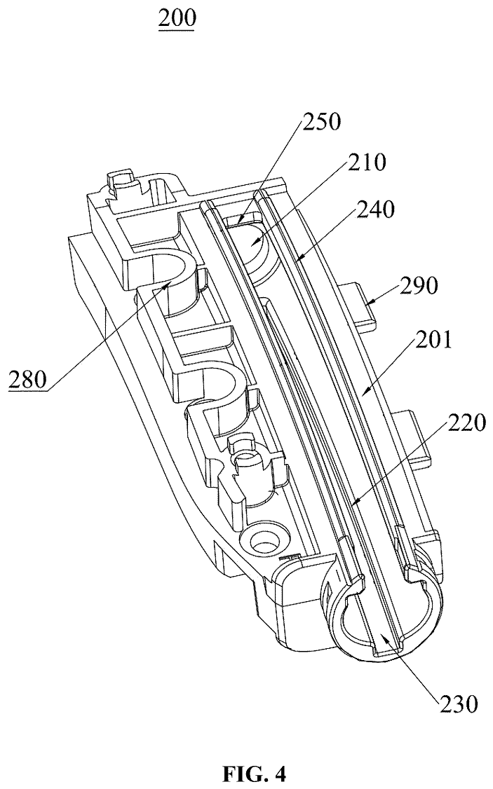

The sliding brackets 200 are disposed in the headband housing 100. As shown in FIG. 4, a sliding bracket 200 is provided with a first through hole 210 for a respective one of the adjustment members 300 to be inserted through. In some embodiments, the extension direction of the sliding bracket 200 is the same as the extension direction of the headband housing 100, and the extension direction of the first through hole 210 is the same as the extension direction of the sliding bracket 200. The adjustment member 300 is movably inserted through the first through hole 210 along the extension direction of the first through hole 210, extends out from an extension opening 101, and is connected to an headset body 900. The first through hole 210 is provided and is able to guide the movement of the adjustment member 300. Thus, the adjustment member 300 is movable relative to the headband housing 100 along the extension direction of the headband housing 100, thereby preventing the interference between the adjustment member 300 and the headband housing 100 during the movement of the adjustment member 300.

For example, a wire 500 is further disposed in the headband housing 100. The middle portion of the wire 500 is located in the headband housing 100. Two ends of the wire 500 respectively extend out from the two extension openings 101 and are electrically connected to the headset bodies 900 so that the two headset bodies 900 are able to be electrically connected to each other.

In the embodiment of the present disclosure, a damping compression assembly 400 is connected to the adjustment member 300 and is used for compressing and fixing the adjustment member 300 to the sliding bracket 200. Thus, the adjustment member 300 is slidably connected to the sliding bracket 200 in a damping manner. It is to be noted that the damping compression assembly 400 compresses and fixes the adjustment member 300 to the sliding bracket 200, which does not mean that the adjustment member 300 is limited and cannot move relative to the sliding bracket 200. Instead, when the adjustment member 300 is subjected to no external force, the adjustment member 300 is limited and cannot move relative to the sliding bracket 200. Moreover, when the adjustment member 300 is subjected to an external force of a set magnitude, for example, the adjustment member 300 is pulled or pushed through the portion of the adjustment member 300 outside the headband housing 100, the adjustment member 300 is able to overcome the frictional force between the adjustment member 300 and the sliding bracket 200 and move relative to the sliding bracket 200. Thus, the movement of the adjustment member 300 relative to the sliding bracket 200 is implemented.

In some embodiments, the damping compression assembly 400 has a compression surface 410 for being abutted against the sliding bracket 200. The compression surface 410 is abutted against the sliding bracket 200 to compress and fix the adjustment member 300 to the sliding bracket 200.

The headset is provided in the embodiment of the present disclosure. The sliding bracket 200 is disposed in the headband housing 100. The adjustment member 300 is movably inserted through the first through hole 210 of the sliding bracket 200 so that the first through hole 210 does not limit the movement of the adjustment member 300 but only guides the movement of the adjustment member 300. One end portion of the adjustment member 300 extends out from the extension opening 101 of the headband housing 100 and is connected to the headset body 900 so that the adjustment member 300 and the headset body 900 connected to the adjustment member 300 are able to move synchronously. The damping compression assembly 400 is connected to the adjustment member 300 and is used for compressing and fixing the adjustment member 300 to the sliding bracket 200. Thus, the adjustment member 300 is slidably connected to the sliding bracket 200 in a damping manner. When the external force to which the adjustment member 300 is subjected exceeds a set value, the adjustment member 300 is movable relative to the sliding bracket 200. The step size of the movement of the adjustment member 300 is related to the magnitude at which the adjustment member 300 is pulled or pushed. Since the limitation of the adjustment member 300 relative to the sliding bracket 200 is implemented by a frictional force generated through compression, the adjustment member 300 is able to rest at any position on the sliding bracket 200. Additionally, the minimum step size of the movement of the adjustment member 300 is able to be relatively small so that the headset body 900 is able to move at a relatively small magnitude. Thus, the stepless adjustment can be implemented and the adjustment member 300 and the headset bodies 900 are limited to any position so that the headset bodies 900 are adjustable to completely fit with the user's ears to better cover the ears. In this manner, the wearing effect of the headset is improved, thereby ensuring the sound quality and sound effect of the headset.

For example, the material of the sliding bracket 200 may be plastic or another non-metal material and is not limited in the embodiment of the present disclosure.

In the embodiment of the present disclosure, two sliding brackets 200, two adjustment members 300, and two damping compression assemblies 400 are provided. The two sliding brackets 200 are in a one-to-one correspondence with the two adjustment members 300, and the two damping compression assemblies 400 are in a one-to-one correspondence with the two adjustment members 300. The two sliding brackets 200 are disposed at two ends of the headband housing 100 and are each configured to be adjacent to end portion of the headband housing 100. The two adjustment members 300 are correspondingly inserted through the first through holes 210 of the two sliding brackets 200. The two damping compression assemblies 400 are correspondingly connected to the two adjustment members 300 and are used for compressing and fixing each of the adjustment members 300 to a respective one of the sliding brackets 200. Thus, each adjustment member 300 can be slidably connected to a respective sliding bracket 200 in a damping manner. The two headset bodies 900 are correspondingly connected to the two adjustment members 300. Thus, the positions of the two headset bodies 900 can be adjusted, thereby further improving the wearing comfort of the headset.

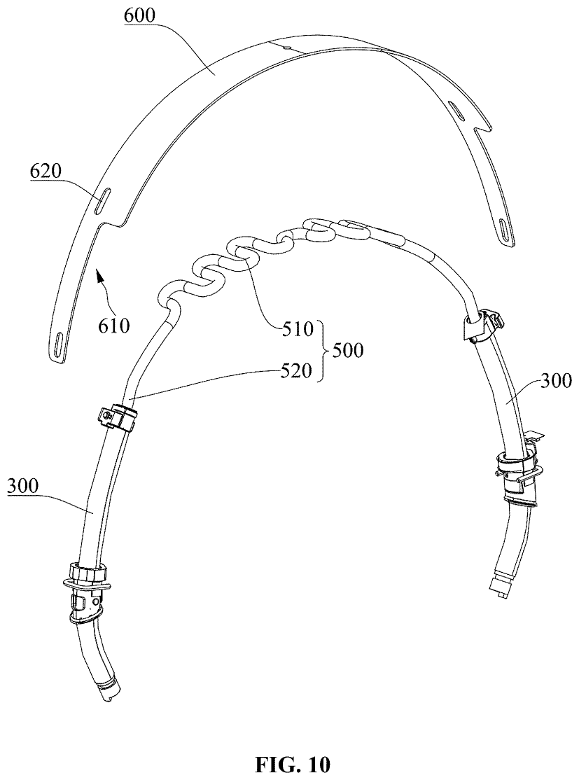

In the embodiment of the present disclosure, as shown in FIG. 10, the middle portion of the wire 500 is located in the headband housing 100. The two ends of the wire 500 correspondingly pass through the two adjustment members 300 and are electrically connected to the two headset bodies 900. In an example, one end of the wire 500 is passed through a corresponding adjustment member 300 along the axial direction of the adjustment member 300 and is electrically connected to the headset bodies 900 that are connected to the adjustment members 300. In the embodiment of the present disclosure, the wire 500 includes a wavy section 510 and two arc-shaped sections 520. The arc-shaped sections 520 are connected to two ends of the wavy section 510. The arc-shaped sections 520 are inserted through the adjustment members 300 and are electrically connected to the headset bodies 900.

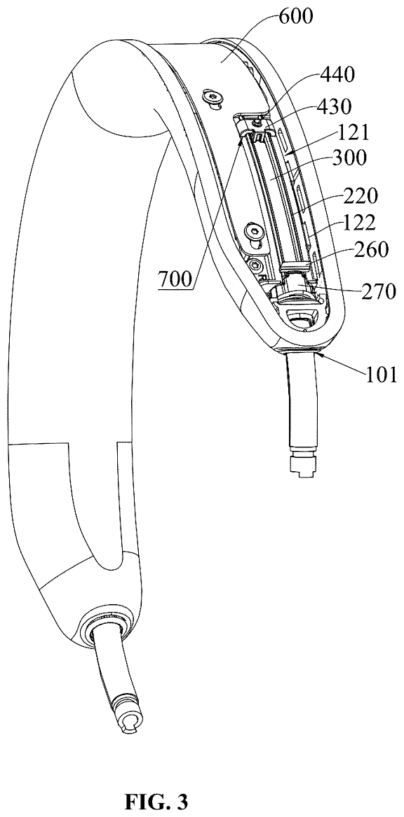

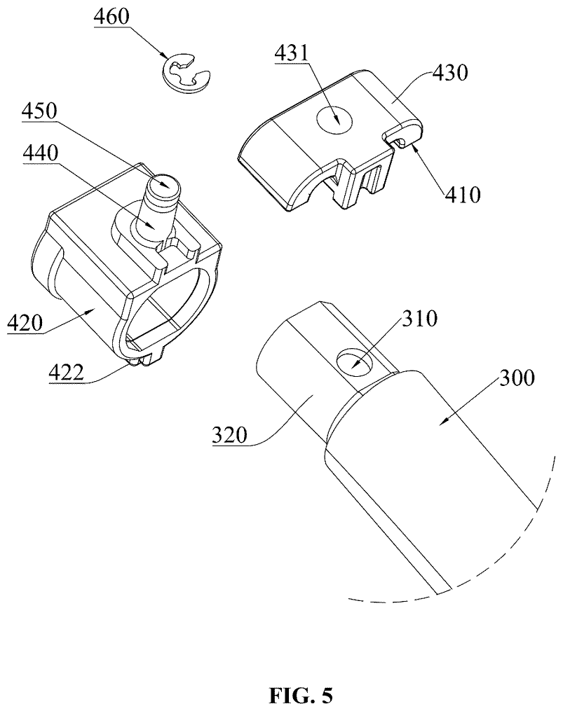

For example, as shown in FIGS. 3 and 5, the damping compression assembly 400 includes a connecting sleeve 420, a compression block 430, and a connector 440. In the embodiment of the present disclosure, the connecting sleeve 420 is sleeved on the adjustment member 300. As shown in FIG. 4, a feature side surface 201 of the sliding bracket 200 is provided with a guide groove 220 communicating with the first through hole 210. The compression block 430 is passed through the guide groove 220 and is abutted against the connecting sleeve 420. The connector 440 connects the compression block 430 to the connecting sleeve 420, and the compression block 430 is provided with a compression surface 410 abutted against the feature side surface 201.

In the embodiment of the present disclosure, the connecting sleeve 420 is configured to be sleeved on the adjustment member 300 so that the strength of the connection between the connecting sleeve 420 and the adjustment member 300 can be enhanced. Thus, it is ensured that when the adjustment member 300 moves, the connecting sleeve 420 can move along with the adjustment member 300. The feature side surface 201 refers to any side surface of the sliding bracket 200. To facilitate assembly, in the embodiment of the present disclosure, the feature side surface 201 is a side surface that is able to be exposed. The guide groove 220 is used for guiding the movement of the compression block 430 so that the compression block 430 is movable along the length direction (that is, the extension direction of the sliding bracket 200) of the guide groove 220. The compression block 430 is abutted against the connecting sleeve 420 so that the connector 440 can connect the connecting sleeve 420 and the compression block 430 into an integrated structure. Thus, the probability of relative displacement between the connecting sleeve 420 and the compression block 430 is reduced, thereby further ensuring that the compression block 430 and the connector 440 are movable along with the adjustment members 300.

In the embodiment of the present disclosure, the compression surface 410 is abutted against the feature side surface 201 so that the contact area between the compression block 430 and the sliding bracket 200 is relatively large. Thus, the frictional force between the compression block 430 and the sliding bracket 200 can be increased, thereby improving the compression effect of the compression block 430 on the adjustment members 300, reducing the risk that the adjustment members 300 move relative to the sliding bracket 200 in the case where the adjustment members 300 are subjected to no force, and improving the reliability of the headset and prolonging the service life of the headset.

For example, the compression block 430 may be made of a non-metal material such as plastic, thereby resulting in a relatively large frictional force between the compression block 430 and the sliding bracket 200. Thus, the compression and fixation of the adjustment member 300 are implemented. In some embodiments, the portion of the compression block 430 for contact with the sliding bracket 200 may be made of a non-slip and wear-resistant material, which is not limited in the embodiment of the present disclosure.

In some embodiments, with continued reference to FIG. 5, the compression block 430 is provided with a second through hole 431, and the extension direction of the second through hole 431 is perpendicular to the sliding direction of the compression block 430. The connector 440 is inserted through the second through hole 431. One end of the connector 440 is connected to the connecting sleeve 420, and a cap portion 450 is disposed at the other end of the connector 440. The damping compression assembly 400 in the embodiment of the present disclosure further includes an elastic member 460. The elastic member 460 is sleeved on the connector 440 and disposed between the cap portion 450 and the compression block 430. The elastic member 460 always has a movement trend to drive the compression block 430 to compress the adjustment member 300 against the sliding bracket 200 so that the adjustment member 300 is elastically compressed on the sliding bracket 200. Relying on the elasticity of the elastic member 460, the adjustment member 300 is tightly compressed on the sliding bracket 200 under the action of the elastic member 460. The elastic member 460 is able to remain elastic for a long period of time. Compared with a connection manner relying on only the connector 440, this configuration can prolong the service life of the headset.

For example, the elastic member 460 is a spring washer, and the connector 440 is provided with a slot. One sidewall of the slot forms the bottom surface of the cap portion 450. The spring washer is at least partially located in the slot so that the spring washer can be abutted against the cap portion 450. Of course, it is to be understood that the elastic member 460 may be another elastic structure, such as a compression spring. The type of the elastic member 460 is not limited in the embodiment of the present disclosure.

In some embodiments, as shown in FIG. 9, the connecting sleeve 420 is provided with a first threaded hole 421. As shown in FIG. 5, the adjustment member 300 is provided with a second threaded hole 310. The connector 440 is in threaded connection to the first threaded hole 421 and the second threaded hole 310 so that the adjustment member 300 is connected to the connecting sleeve 420. In the embodiment of the present disclosure, the connector 440 is used for not only connecting the compression block 430 to the connecting sleeve 420 but also connecting the adjustment member 300 to the connecting sleeve 420, thereby implementing multiple uses of the connector 440. Thus, fewer components are required for the connection when the strength of the connection between the connecting sleeve 420 and the adjustment member 300 is enhanced, so that the headset has fewer parts and a relatively simple structure, and the assembly is also convenient.

In some embodiments, the end of the connector 440 is abutted against the wire 500 in the adjustment member 300 to limit the position of the wire 500 relative to the adjustment member 300. Thus, when the adjustment member 300 moves, the wire 500 can move simultaneously along with the adjustment member 300, thereby improving the movement synchronicity between the wire 500 and the adjustment member 300.

In some embodiments, the adjustment member 300 has a small-diameter end 320 having a relatively small diameter. The connecting sleeve 420 is sleeved on the small-diameter end 320 so that the provision of the connecting sleeve 420 does not excessively increase the dimension of the headset in the radial direction of the adjustment member 300.

For example, one of the hole wall of the first through hole 210 and the outer peripheral wall surface of the connecting sleeve 420 is provided with a first sliding groove 230, and the other one of the hole wall of the first through hole 210 and the outer peripheral wall surface of the connecting sleeve 420 is provided with a sliding block 422. The extension direction of the first sliding groove 230 is the same as the extension direction of the first through hole 210. The sliding block 422 is slidably connected to the first sliding groove 230 along the extension direction of the first sliding groove 230 so that the movement of the connecting sleeve 420 is guided, thereby guiding the movement of the adjustment member 300. Additionally, the friction between the sliding block 422 and the first sliding groove 230 can increase the damping between the connecting sleeve 420 and the sliding bracket 200, thereby further reducing the risk that the connecting sleeve 420 and the adjustment member 300 move relative to the sliding bracket 200 in the case where the connecting sleeve 420 and the adjustment member 300 are subjected to no force. As shown in FIG. 4, the first sliding groove 230 is provided on the hole wall of the first through hole 210, that is, the first sliding groove 230 is provided on the sliding bracket 200. As shown in FIG. 5, the sliding block 422 is provided on the connecting sleeve 420. The sliding block 422 is provided on the connecting sleeve 420 so that the sliding block 422 can have a relatively small dimension, which can reduce the overall weight of the headset.

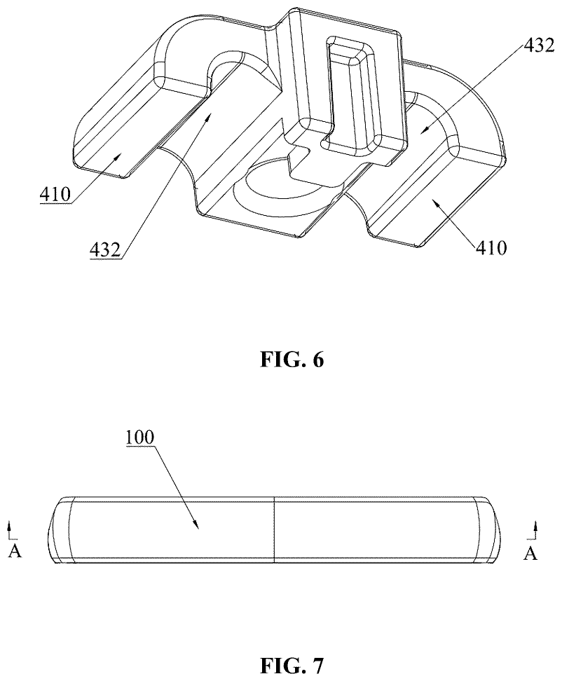

In some embodiments, with continued reference to FIG. 4, the sliding bracket 200 is provided with sliding rails 240 extending along the extension direction (that is, the extension direction of the sliding bracket 200) of the first through hole 210. As shown in FIG. 6, the compression block 430 is provided with second sliding grooves 432 in a sliding fit with the sliding rails 240. The compression block 430 is slidably connected to the sliding rails 240 through the second sliding grooves 432 so that the sliding rails 240 are able to guide the movement of the compression block 430. For example, the number of the sliding rails 240 is two. The two sliding rails 240 are provided on two sides of the guiding groove 220 in the width direction. Correspondingly, the number of the second sliding grooves 432 is two. Each of the two second sliding grooves 432 is in a sliding fit with a respective one of the two sliding rails 240. In the embodiment of the present disclosure, two compression surfaces 410 are provided. The two compression surfaces 410 are provided on sides of the two second sliding grooves 432 facing away from the guiding groove 220 and fit snugly with the feature side surface 201 of the sliding bracket 200.

In some embodiments, as shown in FIG. 3, a collar 270 and a first limit structure 260 are disposed at one end of the sliding bracket 200, and a second limit structure 250 is disposed at the other end of the sliding bracket 200. The compression block 430 is disposed between the first limit structure 260 and the second limit structure 250. The first limit structure 260 and the second limit structure 250 are each used for limiting the compression block 430, thereby limiting the movement limit of the adjustment member 300.

As shown in FIG. 3, in the embodiment of the present disclosure, the collar 270 is connected to the headband housing 100 and is located on a side of the first limit structure 260 facing away from the second limit structure 250. The adjustment member 300 is inserted through the collar 270.

In the embodiment of the present disclosure, the compression block 430 has a first position 700 and a second position 800. The compression block 430 has the first position 700 and the second position 800 relative to the sliding bracket 200. The length of the adjustment member 300 extending out from the extension opening 101 when the compression block 430 is at the first position 700 is greater than the length of the adjustment member 300 extending out from the extension opening 101 when the compression block 430 is at the second position 800. That is, the compression block 430 at the first position 700 is closer to an end portion of the headband housing 100 than the compression block 430 at the second position 800. The first limit structure 260 is used for contact with the compression block 430 at the first position 700 and the second limit structure 250 is used for contact with the compression block 430 at the second position 800 so that the movement limit of the compression block 430 in the extension direction of the first through hole 210 is limited.

It is to be noted that since the collar 270 is disposed on the side of the first limit structure 260 facing away from the second limit structure 250, the compression block 430 at the first position 700 is abutted against or collided with the first limit structure 260, instead of being collided with the collar 270. Thus, the probability that the collar 270 shakes due to a collision is reduced, thereby ensuring the stability of the position of the collar 270.

For example, each of the first limit structure 260 and the second limit structure 250 may be a limit block. Alternatively, the first limit structure 260 and the second limit structure 250 may be groove walls of the guide groove 220. the embodiment of the present disclosure does not limit the form of each of the limit structures.

In some embodiments, as shown in FIGS. 3 and 10, the headset further includes a support sheet 600. The support sheet 600 is slidably connected to the sliding bracket 200 and is used for providing a clamping force in the radial direction of the headband housing 100. Thus, the headband housing 100 is able to be clamped to the user's head so that the headset bodies 900 fit more snugly with the user in the thickness direction of each of the headset bodies 900. In this manner, sound leakage is prevented and the sound effect is further improved. The support sheet 600 has the same shape as the headband housing 100, and two ends of the support sheet 600 extend to the two end portions of the headband housing 100 to provide a deformation force.

In the embodiment of the present disclosure, the support sheet 600, the sliding bracket 200, and the damping compression assembly 400 are all disposed in the headband housing 100. Thus, the headset has a better overall appearance, and the support sheet 600, the sliding bracket 200, and the damping compression assembly 400 can be protected against dust.

For example, the material of the support sheet 600 may be steel or another metal and is not limited in the embodiment of the present disclosure.

In some embodiments, the headband housing 100 includes an upper housing 110 and a lower housing 120 that are in snap-fit connection to each other. The lower housing 120 is closer to the geometric center of the headset than the upper housing 110. That is, the headband housing 100 is arc-shaped, where the lower housing 120 is located on the inner ring, and the upper housing 110 is located on the outer ring. For example, the upper housing 110 and the lower housing 120 may be connected to each other through engagement, a bolt, or magnetic attraction. The connection manner of the upper housing 110 and the lower housing 120 is not limited in the embodiment of the present disclosure.

As shown in FIG. 3, the lower housing 120 is provided with a mounting slot 121. The support sheet 600, the sliding bracket 200, and the damping compression assembly 400 are all disposed in the mounting slot 121. The sliding bracket 200 is connected to the lower housing 120. The support sheet 600, the sliding bracket 200, and the damping compression assembly 400 are all disposed in the mounting slot 121 of the lower housing 120, which can facilitate the assembly of the sliding brackets 200 on the lower housing 120 on one hand and can facilitate the assembly of the upper housing 110 and the lower housing 120 on the other hand, compared with the case where the support sheet 600, the sliding bracket 200, and the damping compression assembly 400 are connected to the upper housing 110. Thus, good final assembly of the headset is implemented.

For example, the support sheet 600 is disposed on a side of the sliding bracket 200 facing away from the bottom wall of the mounting slot 121. Thus, the support sheet 600 can deform in the gap between the sliding bracket 200 and the upper housing 110, and a relatively large deformation space is provided. The space between the sliding bracket 200 and the upper housing 110 can be fully utilized without affecting the connection between each of the sliding bracket 200 and the lower housing 120. Thus, the headband housing 100 is relatively thin as a whole, and a light and thin design of the headband housing 100 is facilitated.

In some embodiments, as shown in FIG. 10, the support sheet 600 and the damping compression assembly 400 are disposed on the same side of the sliding bracket 200. The support sheet 600 is provided with an avoidance slot 610 for avoiding the damping compression assembly 400. At least part of the compression block 430 is located in the avoidance slot 610, and the avoidance slot 610 is used for avoiding the compression block 430. Thus, the compression block 430 and the support sheet 600 are on the same plane. Compared with the configuration manner in which the support sheet 600 extends to a side of the compression block 430 facing away from the sliding bracket 200, this configuration can reduce the thickness of the headband housing 100 on the premise that the support function of the support sheet 600 is ensured. Thus, the light and thin design of the headband housing 100 is facilitated. Moreover, the avoidance slot 610 is provided so that the overall weight of the support sheet 600 can be relatively light, which facilitates the light and thin design of the headset.

In the embodiment of the present disclosure, two avoidance slots 610 are provided and are used for avoiding compression blocks 430 of two damping compression assemblies 400. Thus, the thickness and weight of the headband housing 100 are further reduced.

In some embodiments, with continued reference to FIG. 10, the support sheet 600 is further provided with elongated holes 620. The length direction of each of the elongated holes 620 is the same as the length direction of the support sheet 600. A bolt passes through each of the elongated holes 620 to connect the support sheet 600 to the sliding brackets 200, and the bolt is slidable in each of the elongated holes 620 so that the support sheet 600 is slidably connected to the sliding brackets 200.

In some embodiments, as shown in FIG. 4, the sliding bracket 200 is provided with support protrusions 280. The support protrusions 280 are located on a side of the guide groove 220 to support the support sheet 600. Thus, the case is avoided where the deformation capability of the support sheet 600 is affected because the support sheet 600 is in a suspended state. In the embodiment of the present disclosure, the sliding bracket 200 is connected to the lower housing 120 through a bolt, and the bolt is located between the support protrusions 280. Thus, the provision of the bolt does not increase the thickness of the headband housing 100.

In the embodiment of the present disclosure, as shown in FIGS. 3 and 4, the sidewall of the sliding bracket 200 is provided with snaps 290, and the inner wall of the lower housing 120 is provided with snapping slots 122 that are in a snap fit with the snaps 290. The snaps 290 are snapped into the snapping slots 122. On one hand, the lower housing 120 and the sliding bracket 200 can be positioned. On the other hand, the strength of the connection between the lower housing 120 and the sliding bracket 200 can be enhanced.

When the headset provided in the embodiment of the present disclosure is assembled, the sliding brackets 200 may be first fixed to the lower housing 120. Then, the connecting sleeves 420 and the adjustment members 300 are mounted. Next, the adjustment members 300 are controlled to pass through the sliding brackets 200 and the collars 270 and extend out from the extension openings 101. Then, the wire 500 is caused to pass through the adjustment members 300 and the headset bodies 900 are connected to the adjustment members 300 and the wire 500. Subsequently, the compression blocks 430 are connected to the connecting sleeves 420 through the connectors 440, thereby connecting the compression blocks 430 to the adjustment members 300. Finally, the support sheet 600 is mounted on the sliding brackets 200, and the upper housing 110 is snapped in place so that the assembly of the headset is completed.

When the headset provided in the embodiment of the present disclosure is used, the headset bodies 900 may be pulled or pushed so that the headset bodies 900 drive the adjustment members 300 to slide relative to the sliding brackets 200. When the adjustment members 300 move, the adjustment members 300 drive, through the connecting sleeves 420, the compression blocks 430 to slide relative to the sliding brackets 200 so as to overcome the friction therebetween to move. When an external force is removed, since a relatively large frictional force exists between the compression block 430 and the sliding bracket 200, the adjustment members 300 doe not continue sliding relative to the sliding brackets 200 but remain motionless, thereby limiting the headset bodies 900. It is to be noted that the frictional force between the sliding brackets 200 and the compression blocks 430 is greater than the combined gravity of the headset bodies 900 and the adjustment members 300. Therefore, the adjustment members 300 will not move by themself and have relatively high reliability.

It is to be noted that the preceding are only preferred embodiments of the present disclosure and technical principles used therein. It is to be understood by those skilled in the art that the present disclosure is not limited to the embodiments described herein. Those skilled in the art can make various apparent modifications, adaptations, and substitutions without departing from the scope of the present disclosure. Therefore, while the present disclosure has been described in detail through the preceding embodiments, the present disclosure is not limited to the preceding embodiments and may include more other equivalent embodiments without departing from the concept of the present disclosure. The scope of the present disclosure is determined by the scope of the appended claims.

What is claimed is:

1. A headset, comprising a headband housing and an headset body, wherein the headband housing is provided with an extension opening and the headset further comprises:
a sliding bracket disposed in the headband housing and provided with a first through hole;
an adjustment member movably inserted through the first through hole, extending out from the extension opening, and connected to the headset body; and
a damping compression assembly connected to the adjustment member and used for compressing and fixing the adjustment member to the sliding bracket.

2. The headset according to claim 1, wherein the damping compression assembly comprises a connecting sleeve, a compression block, and a connector, the connecting sleeve is sleeved on the adjustment member, a feature side surface of the sliding bracket is provided with a guide groove communicating with the first through hole, the compression block is passed through the guide groove and is abutted against the connecting sleeve, the connector connects the compression block to the connecting sleeve, and the compression block is provided with a compression surface abutted against the feature side surface.

3. The headset according to claim 2, wherein the compression block is provided with a second through hole, the connector is inserted through the second through hole, one end of the connector is connected to the connecting sleeve, and a cap portion is disposed at another end of the connector; and
the damping compression assembly further comprises an elastic member, the elastic member is sleeved on the connector and disposed between the cap portion and the compression block, and the elastic member always has a movement trend to drive the compression block to compress the adjustment member against the sliding bracket.

4. The headset according to claim 3, wherein the connecting sleeve is provided with a first threaded hole, the adjustment member is provided with a second threaded hole, and the connector is in threaded connection to the first threaded hole and the second threaded hole to connect the connecting sleeve to the adjustment member.

5. The headset according to claim 2, wherein one of a hole wall of the first through hole and an outer peripheral wall surface of the connecting sleeve is provided with a first sliding groove, another one of the hole wall of the first through hole and the outer peripheral wall surface of the connecting sleeve is provided with a sliding block, an extension direction of the first sliding groove is the same as an extension direction of the first through hole, and the sliding block is slidably connected to the first sliding groove along the extension direction of the first sliding groove.

6. The headset according to claim 2, wherein the sliding bracket is provided with a sliding rail extending along the extension direction of the first through hole, and the compression block is provided with a second sliding groove in a sliding fit with the sliding rail.

7. The headset according to claim 2, wherein one of a hole wall of the first through hole and an outer peripheral wall surface of the connecting sleeve is provided with a first sliding groove, another one of the hole wall of the first through hole and the outer peripheral wall surface of the connecting sleeve is provided with a sliding block, an extension direction of the first sliding groove is the same as an extension direction of the first through hole, and the sliding block is slidably connected to the first sliding groove along the extension direction of the first sliding groove; and
the sliding bracket is provided with a sliding rail extending along the extension direction of the first through hole, and the compression block is provided with a second sliding groove in a sliding fit with the sliding rail.

8. The headset according to claim 2, wherein a collar and a first limit structure are disposed at one end of the sliding bracket, a second limit structure is disposed at another end of the sliding bracket, the collar is connected to the headband housing and located on a side of the first limit structure facing away from the second limit structure, and the adjustment member is inserted through the collar; and
the compression block has a first position and a second position, a length of the adjustment member extending out from the extension opening when the compression block is at the first position is greater than a length of the adjustment member extending out from the extension opening when the compression block is at the second position, and the first limit structure is used for contact with the compression block at the first position and the second limit structure is used for contact with the compression block at the second position so that a movement limit of the compression block in an extension direction of the first through hole is limited.

9. The headset according to claim 1, wherein two headset bodies, two sliding brackets, two adjustment members, and two damping compression assemblies are provided, the two sliding brackets are respectively disposed at two ends of the headband housing, the two adjustment members are correspondingly inserted through first through holes of the two sliding brackets, the two damping compression assemblies are correspondingly connected to the two adjustment members and are used for compressing and fixing each of the adjustment members to a respective one of the sliding brackets, the two headset bodies are correspondingly connected to the two adjustment members, the headset further comprises a wire, a middle portion of the wire is located in the headband housing, and two ends of the wire are correspondingly passed through the adjustment members and are electrically connected to the two headset bodies.

10. The headset according to claim 1, further comprising a support sheet slidably connected to the sliding bracket, and the support sheet, the sliding bracket, and the damping compression assembly are all disposed in the headband housing.

11. The headset according to claim 2, further comprising a support sheet slidably connected to the sliding bracket, and the support sheet, the sliding bracket, and the damping compression assembly are all disposed in the headband housing.

12. The headset according to claim 3, further comprising a support sheet slidably connected to the sliding bracket, and the support sheet, the sliding bracket, and the damping compression assembly are all disposed in the headband housing.

13. The headset according to claim 4, further comprising a support sheet slidably connected to the sliding bracket, and the support sheet, the sliding bracket, and the damping compression assembly are all disposed in the headband housing.

14. The headset according to claim 5, further comprising a support sheet slidably connected to the sliding bracket, and the support sheet, the sliding bracket, and the damping compression assembly are all disposed in the headband housing.

15. The headset according to claim 6, further comprising a support sheet slidably connected to the sliding bracket, and the support sheet, the sliding bracket, and the damping compression assembly are all disposed in the headband housing.

16. The headset according to claim 7, further comprising a support sheet slidably connected to the sliding bracket, and the support sheet, the sliding bracket, and the damping compression assembly are all disposed in the headband housing.

17. The headset according to claim 8, further comprising a support sheet slidably connected to the sliding bracket, and the support sheet, the sliding bracket, and the damping compression assembly are all disposed in the headband housing.

18. The headset according to claim 9, further comprising a support sheet slidably connected to the sliding bracket, and the support sheet, the sliding bracket, and the damping compression assembly are all disposed in the headband housing.

19. The headset according to claim 10, wherein the headband housing comprises an upper housing and a lower housing that are in snap-fit connection to each other, the lower housing is closer to a geometric center of the headset than the upper housing, the lower housing is provided with a mounting slot, the support sheet, the sliding bracket, and the damping compression assembly are all disposed in the mounting slot, the sliding bracket is connected to the lower housing, and the support sheet is disposed on a side of the sliding brackets facing away from a bottom wall of the mounting slot.

20. The headset according to claim 10, wherein the support sheet and the damping compression assembly are disposed on a same side of the sliding bracket.
